(19) United States
(12) Patent Application Publication
(10) Pub. No.: US 2026/0254881 A1
(43) Pub. Date: Aug. 27, 2026

(54) GLOBAL MULTI-SYSTEM, MULTI-LAYER, GREEN AND AI-ENHANCED SWITCH CODE FINANCIAL ARCHITECTURE WITH CONTAINERIZED PRIVACY AND COMPLIANCE MANAGEMENT METHODS AND APPLICATIONS

(71) Applicant: FURONG BEI, SAN GABRIEL, CA (US)

(72) Inventor: FURONG BEI, SAN GABRIEL, CA (US)

(21) Appl. No.: 19/064,689

(22) Filed: Feb. 27, 2025

(51) Int. Cl. H04L 67/50; G06F 21/60; G06Q 20/40; G06Q 30/018

(52) U.S. Cl. CPC H04L 67/50; G06F 21/602; G06Q 20/4016; G06Q 30/018

(57) ABSTRACT

Behavioral Economics Identity (BEI) Switch Code architecture operates policy-controlled financial-service endpoints through a tamper-evident record that binds an institution or endpoint to jurisdiction, fee schedule, KYC/AML tier, risk state, proof rule, container endpoint, ESG metric, and audit pointer. A SwitchRegistry maintains the record; a container orchestrator deploys a financial-service container with a compliance probe that reads the record before service execution. A settlement module processes multi-asset transactions under record-defined limits and generates tamper-evident receipts. An AI risk engine updates states including watch, partial freeze, proof requested, and staged unfreeze. Privacy-preserving proofs verify compliance attributes without exposing underlying data. An energy-aware scheduler routes or migrates workloads according to node-level ESG metrics, coupling ledger state with runtime execution to improve compliance, privacy, auditability, and resilience.

### CROSS-REFERENCE TO RELATED APPLICATIONS

This section is intentionally limited to priority information that is or will be stated in an Application Data Sheet. Any incorporation by reference, priority claim, or family relationship should be controlled by the Application Data Sheet and the official record for this application. The present substitute specification is directed to the subject matter originally disclosed in the above-identified application, including Switch Code records, blockchain-based registration, containerized financial service deployment, artificial-intelligence risk control, multi-signature or DAO governance, zero-knowledge selective disclosure, multi-currency settlement, and green-energy or ESG monitoring.

### STATEMENT REGARDING FEDERALLY SPONSORED RESEARCH OR DEVELOPMENT

Not applicable.

### FIELD OF THE INVENTION

The present disclosure relates to distributed computing systems, financial-technology infrastructure, distributed ledgers, container orchestration, privacy-preserving proof systems, artificial-intelligence risk control, cryptographic audit trails, energy-aware workload scheduling, and multi-asset settlement systems. More particularly, the disclosure relates to a policy-controlled Switch Code architecture in which an institution-level Switch Code record operates as a dynamic registry and state object for deploying and controlling containerized financial services, transaction policies, risk-state transitions, selective disclosures, and audit receipts across heterogeneous networks.

In some embodiments, the disclosed architecture provides a technical control plane for financial service endpoints. The control plane binds a registered institution, domain or subdomain endpoint, distributed-ledger record, containerized service instance, policy bundle, risk state, privacy proof, and settlement receipt into a coordinated machine-implemented workflow.

### BACKGROUND OF THE INVENTION

Conventional cross-border payment, digital banking, and credit systems are typically implemented through siloed institutional systems. Compliance policies, fee schedules, credit thresholds, transaction permissions, fraud controls, and account restrictions may be stored in separate databases, manually configured systems, or vendor-specific rule engines. Such fragmentation increases the likelihood of stale policy application, inconsistent transaction treatment, slow incident response, and excessive disclosure of sensitive identity or credit information.

Distributed ledger and decentralized finance systems can improve transparency and programmability, but many such systems lack institutional-grade compliance control, privacy-preserving disclosure, reversible or staged risk response, and integration with cloud-native service deployment. A smart contract may execute a swap or token transfer, but it usually does not serve as a unified compliance configuration object for a deployed banking microservice, nor does it reliably control the containerized runtime environment through which the service is provided.

Container orchestration systems such as cluster schedulers can deploy microservices at scale, but such orchestration systems generally do not obtain transaction-specific compliance state from a cryptographically verifiable institution-level ledger object. A container may be deployed for a bank, payment provider, lender, or card issuer, but the orchestration system is not normally driven by a registry object that also stores fee schedules, KYC or AML tiers, AI risk thresholds, freeze status, selective-disclosure rules, and environmental or energy metrics.

Artificial intelligence and machine-learning models may be used for fraud detection, credit scoring, or anomaly detection. However, when used separately from a cryptographic registry and policy enforcement layer, an AI model may create opaque decisions, inconsistent enforcement, delayed response, or excessive privacy exposure. Similarly, zero-knowledge or privacy-preserving proof systems can validate selected statements, but such proof systems are often not integrated into a staged freeze and unfreeze workflow for institution-level financial services.

Green-finance and ESG reporting systems commonly operate as separate reporting layers that do not directly control transaction fees, service routing, container workload placement, or node selection. As a result, a system may report energy usage without causing a concrete machine action such as moving a workload to a lower-carbon node, applying a fee coefficient, or generating a verifiable ESG audit receipt.

Accordingly, there is a need for a specific computer-implemented architecture that coordinates a registered financial service identity, a distributed ledger registry, containerized deployment, AI risk evaluation, staged governance response, privacy-preserving disclosure, multi-asset transaction settlement, and energy-aware execution into a unified technical workflow.

### SUMMARY OF THE INVENTION

The disclosure provides a policy-controlled Switch Code architecture for operating financial service endpoints across distributed ledgers and containerized computing environments. A Switch Code record may be minted, registered, or maintained for a participating institution, service provider, domain endpoint, sub-bank, payment provider, credit issuer, lender, or other financial service node. The Switch Code record may include machine-readable fields such as jurisdiction, service scope, fee schedule, KYC tier, AML threshold, credit parameter, oracle source, freeze state, selective-disclosure rule, AI risk factor, container endpoint, ESG metric, policy version, and audit receipt pointer.

In one aspect, a SwitchRegistry contract or equivalent tamper-evident registry maintains Switch Code records. A container orchestration module deploys one or more financial-service containers under a domain or subdomain endpoint and configures a compliance probe or policy sidecar to read the Switch Code record before permitting a service operation. The compliance probe may block, limit, route, log, or permit an operation according to the active policy bundle and risk state associated with the Switch Code record.

In another aspect, a multi-asset exchange or settlement module processes cross-currency or cross-asset transactions by referencing the Switch Code record for applicable fee schedules, risk thresholds, KYC requirements, oracle sources, and transaction limitations. External or internal rate oracles may be consulted, and settlement receipts may be anchored in a tamper-evident data structure.

In another aspect, an AI risk engine evaluates transaction flows, behavior patterns, credit signals, network anomalies, sanctions or watchlist indicators, or operational telemetry. When a calculated risk value exceeds a policy-defined threshold, the system may transition a Switch Code record from a normal state to a watch state, partial freeze state, proof-requested state, full freeze state, or staged unfreeze state. The transition may require multi-signature or DAO approval, regulator participation, or policy-defined quorum approval.

In another aspect, a zero-knowledge or privacy-preserving proof engine provides selective disclosure. A user, institution, or service node may prove that a transaction, identity attribute, credit range, jurisdictional condition, or compliance status satisfies a rule without revealing unnecessary underlying data. A staged unfreeze process may restore service privileges incrementally when acceptable proof objects are verified.

In another aspect, an ESG monitoring component and energy-aware scheduling component track node-level or container-level energy metrics. A scheduler may select, migrate, replicate, or deprioritize service containers according to renewable-energy ratio, carbon score, data center efficiency, policy constraints, and service availability requirements. Fee coefficients, routing priority, or reward values may be adjusted according to the ESG state recorded in or associated with the Switch Code record.

The disclosed architecture improves distributed financial computing by providing a single policy-controlled control object that coordinates runtime deployment, transaction execution, risk response, privacy disclosure, auditability, settlement, and energy-aware scheduling. This combination reduces stale policy enforcement, improves incident response, limits unnecessary disclosure of sensitive data, and creates a machine-verifiable path from a registered financial service endpoint to container execution and ledger-backed settlement.

### BRIEF DESCRIPTION OF THE DRAWINGS

FIG. 1 illustrates an overall policy-controlled Switch Code financial architecture including institution registration, SwitchRegistry, container orchestration, AI risk control, privacy proof, settlement, audit, and ESG monitoring components.

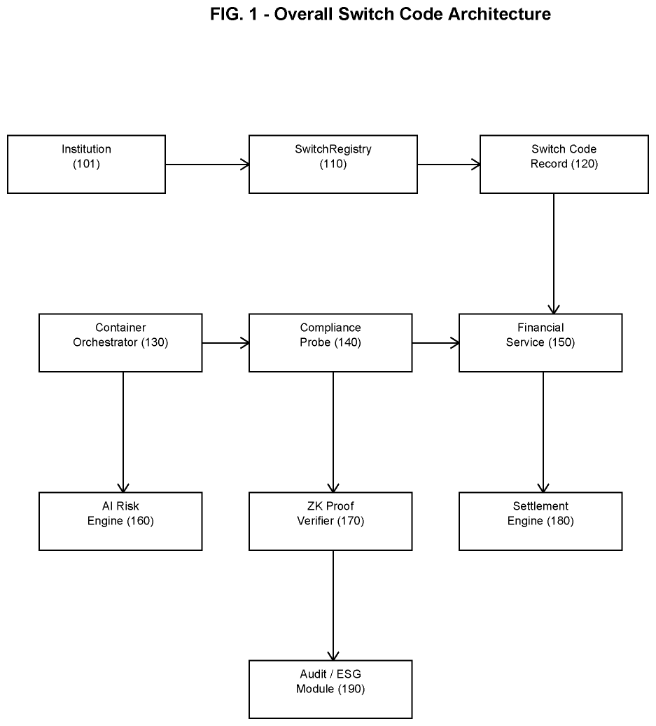

FIG. 2 illustrates a Switch Code minting and registration workflow in which an institution submits registration data and receives a Switch Code record after compliance review.

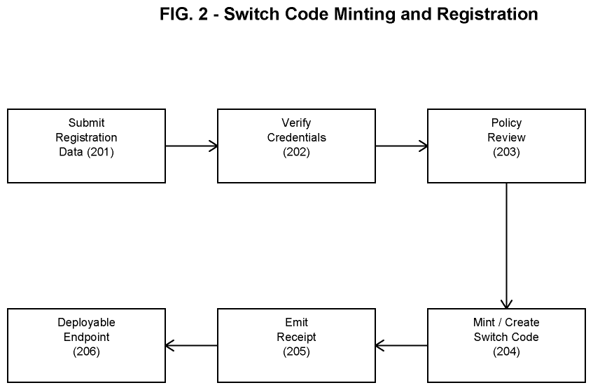

FIG. 3 illustrates a non-limiting Switch Code record and policy bundle data structure.

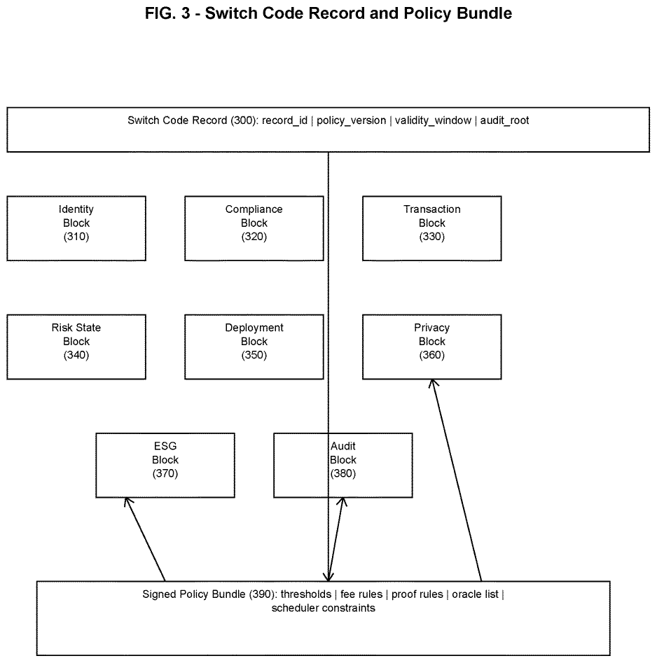

FIG. 4 illustrates domain or subdomain based container deployment with a compliance probe and policy sidecar referencing a Switch Code record.

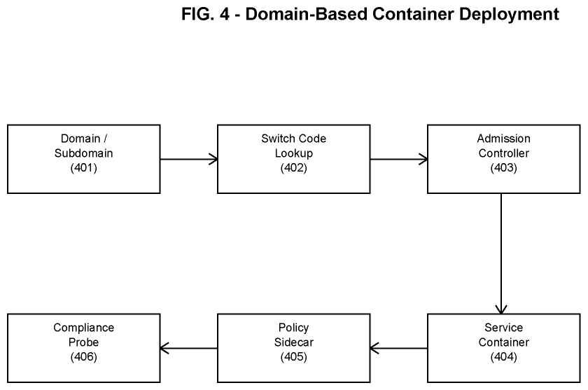

FIG. 5 illustrates a multi-currency liquidity, oracle, fee application, and settlement workflow.

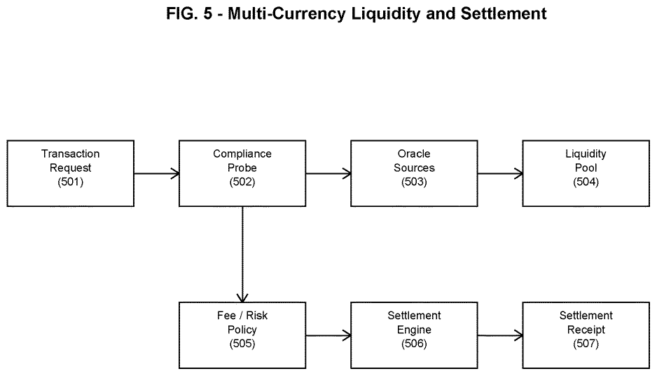

FIG. 6 illustrates an AI risk state machine and partial freeze transition workflow.

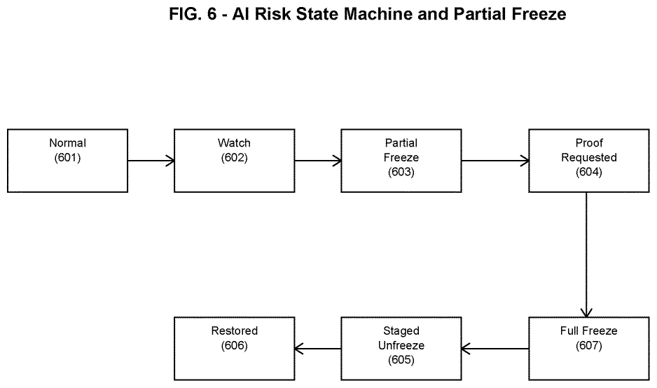

FIG. 7 illustrates multi-signature or DAO governance approval and tamper-evident audit receipt generation.

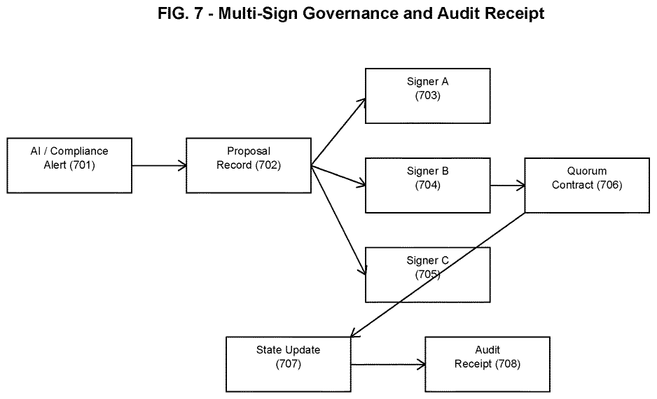

FIG. 8 illustrates zero-knowledge selective disclosure and staged unfreeze after proof verification.

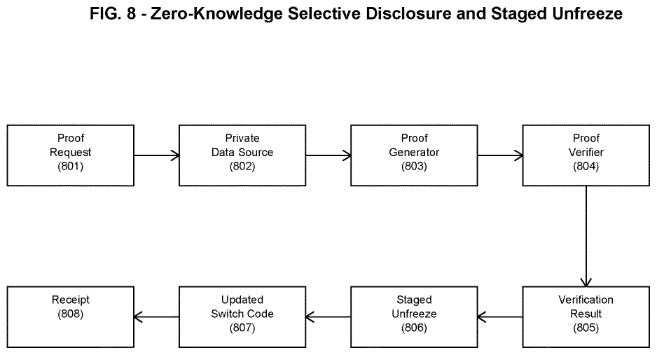

FIG. 9 illustrates an ESG and energy-aware Beehive scheduler for routing or migrating container workloads.

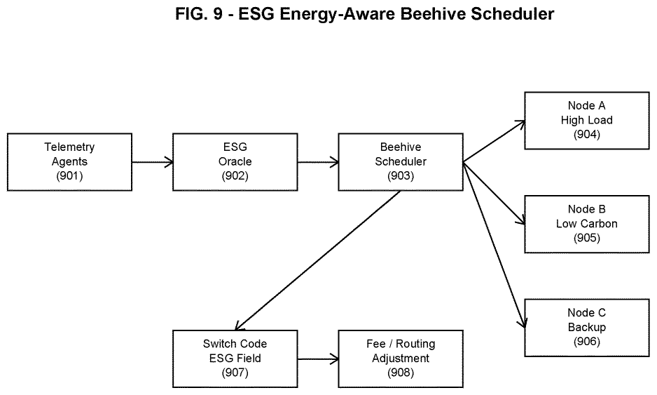

FIG. 10 illustrates an end-to-end computer-implemented method executed by one or more processors.

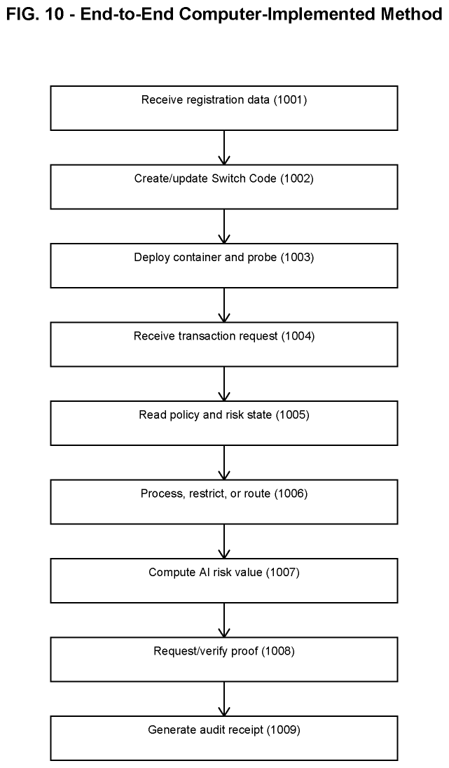

### DETAILED DESCRIPTION OF THE INVENTION

The following description provides non-limiting embodiments of a Switch Code architecture. The terms used in the description are intended to describe example implementations and do not limit the scope of the claims unless expressly recited in the claims. The architecture may be implemented using public blockchains, permissioned ledgers, append-only logs, cloud services, private data centers, hybrid clouds, edge nodes, or combinations thereof.

A Switch Code record may be implemented as a non-fungible token, account-bound token, smart-contract state record, credential object, ledger record, registry entry, database row anchored by a hash commitment, or other tamper-evident data object. The phrase Switch Code NFT is therefore used in some embodiments as an example of a cryptographically verifiable registry object and is not limited to a particular token standard.

A financial service endpoint may include a banking service, payment service, card issuance service, loan service, liquidity service, remittance service, credit service, custody service, digital wallet service, compliance verification service, settlement service, or any combination thereof. The endpoint may be hosted under a domain, subdomain, namespace basepoint, application identifier, or other resolvable identifier.

The system may include one or more processors and one or more memories storing instructions for performing the operations described herein. A distributed ledger node, service container, policy server, AI risk server, zero-knowledge proof verifier, settlement engine, and audit log server may be executed on the same computing device or distributed among multiple devices.

### Definitions and Data Objects

Switch Code Record. A Switch Code record is a machine-readable object representing the operating policy state of an institution, sub-bank, financial endpoint, or service node. The record may include an institution identifier, domain endpoint identifier, jurisdiction code, service permission mask, fee schedule identifier, KYC tier, AML threshold, credit parameter, permitted oracle source, risk score, AI threshold, freeze state, selective disclosure policy, ESG score, container endpoint identifier, policy version, and audit pointer.

SwitchRegistry. A SwitchRegistry is a smart contract, distributed ledger registry, permissioned registry, append-only log, or equivalent tamper-evident registry configured to mint, issue, update, suspend, audit, or revoke Switch Code records.

Policy Bundle. A policy bundle is a signed or versioned set of machine-readable rules that may define authorized service types, jurisdictions, KYC tiers, AML thresholds, credit limits, fee coefficients, oracle endpoints, freeze triggers, proof requirements, audit permissions, ESG thresholds, and validity windows.

Compliance Probe. A compliance probe is a software module associated with a service container or API gateway that reads or verifies a Switch Code record before a transaction or service operation is executed. A compliance probe may be implemented as a sidecar, admission controller, middleware filter, smart-contract call, gateway plugin, or equivalent control mechanism.

Risk State. A risk state is a state value associated with a Switch Code record or transaction flow. Non-limiting states include normal, watch, rate-limited, partial freeze, proof requested, manual review, full freeze, staged unfreeze, and restored.

Selective Disclosure Proof A selective disclosure proof is a cryptographic proof or credential presentation that proves one or more statements without revealing unnecessary underlying data. Examples include zero-knowledge proofs, verifiable credentials, commitments, range proofs, threshold signatures, secure enclave attestations, and equivalent privacy-preserving proof objects.

Beehive Scheduler. A Beehive scheduler is an energy-aware and resilience-aware scheduling process that distributes or migrates workloads among a plurality of nodes according to ESG metrics, renewable-energy availability, data-center efficiency, network latency, load, redundancy, and policy constraints.

### Switch Code Record Structure

In some embodiments, a Switch Code record includes a header portion, identity portion, compliance portion, transaction portion, risk portion, deployment portion, privacy portion, ESG portion, and audit portion. The header portion may include a record identifier, token identifier, registry address, chain identifier, policy version, timestamp, and validity window. The identity portion may include an institution identifier, domain endpoint, subdomain endpoint, customer number, issuer public key, or credential issuer identifier.

The compliance portion may store KYC level, AML level, sanctions status, permitted jurisdictions, prohibited jurisdictions, product eligibility, licensing status, and regulator endpoint. The transaction portion may store fee schedules, maximum daily value, maximum transaction size, liquidity pool identifier, oracle source identifier, settlement route, and stablecoin, CBDC, fiat, or crypto asset compatibility.

The risk portion may store an AI risk score, anomaly score, credit score, fraud score, volatility score, threshold value, freeze state, freeze reason code, freeze expiration time, proof-requested flag, and staged-unfreeze progress value. The deployment portion may store container image identifier, service endpoint URI, namespace, workload class, service health value, policy sidecar identifier, and last deployment hash.

The privacy portion may store a proof policy identifier, permitted proof type, commitment root, verification key identifier, disclosure scope, and data minimization rule. The ESG portion may store energy-source ratio, carbon score, renewable threshold, data center efficiency score, routing priority, green fee coefficient, and sustainability audit pointer. The audit portion may store event receipt hashes, freeze receipts, proof receipts, settlement receipts, governance approvals, and rollback or correction records.

By combining these data fields in a single registry object, the system causes a technical coupling between ledger state and runtime service behavior. A service container or gateway is not merely associated with an institution name; it is controlled by a machine-verifiable Switch Code record whose state determines whether the container may execute particular service functions.

### Switch Code Registration and Minting

A registration workflow may begin when an institution, payment provider, lender, card issuer, wallet provider, or sub-bank submits registration information to a SwitchRegistry or registration gateway. The registration information may include identity credentials, licensing evidence, jurisdiction, requested service types, fee schedule, KYC or AML procedures, ESG disclosures, and container deployment preferences.

The SwitchRegistry or associated governance node may validate the submitted information using one or more of credential verification, signature verification, manual compliance review, regulator approval, oracle lookup, policy bundle validation, and AI-assisted risk screening. When the registration information satisfies applicable rules, the SwitchRegistry creates or mints a Switch Code record and associates the record with the institution and its domain or service endpoint.

The minted Switch Code record may be assigned an initial risk state of normal or provisional. In a provisional state, selected services may be limited until additional information is supplied. The SwitchRegistry may emit a registration event and create a registration receipt that includes at least a record identifier, policy version, institution identifier commitment, and timestamp.

### Domain and Containerized Deployment

In some embodiments, an institution or service node operates under a top-level domain, subdomain, namespace basepoint, or other resolvable identifier. For example, a bank, payment provider, or credit issuer may be associated with a service endpoint under a domain such as a non-limiting ATMS.com-type domain, a regional domain, an institutional domain, or a regulated namespace endpoint.

A container orchestration module receives a deployment request for a financial service. Before creating or updating the corresponding container, the orchestration module queries the SwitchRegistry or verifies a cached Switch Code commitment. If the Switch Code record is valid and policy permits deployment, the container orchestration module deploys a service container with a compliance probe or policy sidecar.

The compliance probe may intercept service requests, read transaction attributes, obtain the active Switch Code state, compare the request against a policy bundle, and output an allow, deny, rate-limit, route, log, proof-request, or freeze action. If the Switch Code record is suspended, expired, or in a freeze state, the probe may block service execution or allow only limited functions such as proof submission, dispute submission, or regulator review.

This coupling between the Switch Code record and the container runtime provides a specific technical improvement over independent container deployment. A container can be automatically configured or disabled according to cryptographically verifiable policy state, thereby reducing stale configuration and preventing a service from continuing to process transactions after a relevant risk-state transition.

### Multi-Asset Exchange and Settlement

A multi-asset exchange or settlement module may process fiat, digital asset, stablecoin, CBDC, tokenized deposit, loyalty unit, or other value units. When a transaction request is received from a service container, the module obtains the applicable Switch Code record and determines whether the transaction is permitted according to the institution profile, user KYC level, transaction amount, jurisdiction, fee schedule, liquidity route, and risk state.

The exchange module may query one or more rate oracles, liquidity pool contracts, market data sources, or internal treasury systems. The module applies a fee or routing coefficient specified by or referenced from the Switch Code record. A settlement receipt may be generated after execution and may include transaction commitments, rate identifiers, fee identifiers, policy version, and audit anchors.

In some embodiments, the transaction may be declined, deferred, partially settled, or routed to a higher-assurance path when the risk state is watch, proof requested, or partial freeze. In other embodiments, low-value or routine transactions may continue while high-value transactions are restricted, thereby reducing downtime while maintaining compliance control.

### AI Risk Engine and Risk State Machine

The AI risk engine may receive input data from transaction logs, container telemetry, API gateway logs, oracle outputs, compliance alerts, credit events, behavior profiles, sanctions-list updates, device fingerprints, network traffic, user actions, and ESG metrics. The engine may apply one or more machine-learning models, rule engines, statistical filters, anomaly detectors, graph-analysis models, or hybrid models to produce a risk score or action recommendation.

A non-limiting risk state machine includes normal, watch, rate-limited, partial freeze, proof requested, manual review, full freeze, staged unfreeze, and restored states. A transition from normal to watch may occur when an anomaly score exceeds a first threshold. A transition to partial freeze may occur when high-value or cross-border transaction risk exceeds a second threshold. A transition to proof requested may occur when a privacy-preserving proof is required to resolve a compliance condition. A transition to full freeze may occur when multi-signature governance approval confirms a severe risk condition.

The AI risk engine may not act alone in some embodiments. A policy bundle may define which risk values cause automatic actions and which values require governance review. The risk engine may output a recommendation, and a multi-signature or DAO governance contract may approve, reject, modify, or escalate the recommended action. The final state transition is recorded in the Switch Code record and anchored in an audit log.

By storing the risk state in or in association with the Switch Code record, the system creates a single machine-verifiable state that can be read by container probes, exchange modules, settlement modules, and proof-verification modules. This prevents inconsistent risk treatment across distributed services.

### Multi-Signature or DAO Governance

A governance module may include a multi-signature contract, DAO contract, regulator node, compliance committee node, institutional administrator node, or other quorum-based approval mechanism. The governance module may approve registry issuance, policy update, freeze, partial freeze, staged unfreeze, revocation, audit export, or settlement exception operations.

In a non-limiting example, a freeze operation requires M of N signatures from authorized compliance actors. Each signer may sign a governance event including the Switch Code record identifier, proposed state, reason code, policy version, expiration time, and evidence commitment. When the approval threshold is met, the SwitchRegistry updates the Switch Code risk state and emits a governance receipt.

The governance module may also support role-based access control. For example, a bank administrator may update fee schedules within approved limits, a regulator node may request audit evidence, an AI auditor may submit anomaly recommendations, and a clearinghouse node may suspend settlement routes when a policy breach is detected.

### Privacy-Preserving Selective Disclosure

A zero-knowledge proof engine or other privacy-preserving proof engine may allow a party to prove that a sensitive value satisfies a policy without revealing the sensitive value. Non-limiting proof statements include: a transaction amount is below a threshold; a user holds a required KYC tier; a lender has a credit parameter within a permitted range; an institution is not on a restricted list; a jurisdiction is permitted; or a service node satisfies a compliance attestation.

In some embodiments, a proof request is generated when a Switch Code record enters a proof-requested or partial-freeze state. The request may specify a proof type, verification key, time window, permitted data source, challenge nonce, and disclosure scope. The responding party generates a proof and submits it to a verification endpoint. If the proof verifies, the SwitchRegistry may transition the record to a staged unfreeze state or restore selected privileges.

The staged unfreeze process may restore privileges incrementally. For example, a first proof may restore low-value domestic transfers, a second proof may restore card issuance services, and a third proof may restore cross-border settlement. Each restoration step may create an unfreeze receipt that references the proof commitment and policy version.

This privacy-preserving workflow reduces unnecessary disclosure of sensitive identity, credit, or transaction data while still permitting a regulator, compliance node, or service operator to enforce policy.

### ESG Monitoring and Beehive Scheduling

An ESG monitoring component may collect energy consumption, compute utilization, carbon intensity, renewable-energy ratio, data center efficiency, regional grid score, and sustainability certification data for nodes hosting financial service containers. The data may be obtained from telemetry agents, infrastructure providers, oracles, data center systems, renewable energy certificates, or other sources.

A Beehive scheduler may distribute workloads among nodes according to load, latency, redundancy, compliance jurisdiction, privacy boundary, and energy metrics. The scheduler may migrate or replicate a container to a lower-carbon node when the policy bundle permits migration and service availability constraints are satisfied. A service may be prioritized for a green route when its Switch Code record satisfies a renewable threshold or carbon score.

The ESG component may update an ESG score associated with the Switch Code record. The exchange or settlement module may apply a fee discount, reward, priority routing, or green certificate when the score satisfies a policy-defined threshold. Conversely, a node that fails to satisfy energy or reporting requirements may lose priority or may be routed to a remediation workflow.

The Beehive scheduler may use a swarm-like scheduling model in which service containers are treated as tasks assigned among a plurality of nodes. Each node reports load and energy values. The scheduler computes a placement score based on a weighted combination of service latency, available capacity, renewable-energy ratio, jurisdictional compatibility, and risk-state requirements. The scheduler selects a node that satisfies hard constraints and optimizes the placement score.

### Audit Receipts and Tamper-Evident Records

The system may generate tamper-evident receipts for registration, policy update, deployment, transaction, risk-state transition, freeze, proof request, proof verification, unfreeze, settlement, ESG update, and audit export. A receipt may include a record identifier, event type, timestamp, policy version, actor commitment, evidence commitment, and hash of relevant data.

Receipts may be stored on a distributed ledger, permissioned ledger, append-only log, Merkle tree, WORM storage, or other integrity-protected structure. Detailed sensitive data may be stored off-chain, with only commitments or encrypted references anchored in the tamper-evident structure. A regulator or auditor may verify that a particular event occurred without receiving all underlying private data.

The audit system may support correction or rollback records. A correction record may reference an original receipt, state the corrected field or state, include authorization evidence, and preserve both the original and corrected records. Such correction does not require arbitrary editing of historical ledger data.

### Quantum-Safe and Cryptographic Variants

The system may use conventional digital signatures, threshold signatures, multi-signature schemes, hash commitments, encryption, verifiable credentials, zero-knowledge proofs, or equivalent cryptographic primitives. In some embodiments, quantum-resistant or post-quantum signature schemes are used to protect Switch Code ownership, governance approval, proof verification, or audit receipts against future cryptographic threats.

Cryptographic keys may be rotated according to a policy bundle. A key rotation event may be recorded in the SwitchRegistry and may update the verification material used by a container compliance probe, settlement module, or proof-verification module.

### Implementation Examples

Example 1—Institutional onboarding. A payment institution applies for a Switch Code record. The system validates licensing data, KYC procedures, fee schedule, ESG disclosures, and service scope. A SwitchRegistry mints a Switch Code record and assigns a provisional state. A container orchestration module deploys a payment gateway container under a service endpoint. The compliance probe reads the provisional state and permits limited transactions until additional proof is supplied.

Example 2—Cross-currency settlement. A registered bank requests a currency conversion for a customer. The multi-asset settlement module reads the Switch Code record, obtains rate data from permitted oracles, applies the institution fee schedule, and checks the risk state. The system executes the conversion and anchors a settlement receipt. If an anomaly score exceeds a threshold, high-value transfers are placed into partial freeze while low-value transactions remain permitted.

Example 3—Privacy-preserving unfreeze. A lender service enters a proof-requested state after the AI risk engine detects unusual loan activity. The system requests a proof that loan exposure is within a permitted range and that the borrower satisfies a required KYC tier. The lender submits a zero-knowledge range proof and credential proof. After verification and multi-sign approval, the system restores selected privileges and records an unfreeze receipt.

Example 4—Energy-aware routing. A service container hosted at a data center reports a low renewable-energy ratio and high carbon score. The Beehive scheduler identifies a compliant node with lower carbon intensity and sufficient capacity. The system migrates the container, updates the deployment hash and ESG score in the Switch Code record, and applies a green fee coefficient to future transactions.

Example 5—Governance update. A regulator publishes a new policy requiring enhanced monitoring for a particular transaction category. A signed policy bundle is submitted to the SwitchRegistry. The registry updates policy version references, container probes refresh their policy cache, and settlement modules begin applying the updated rule within the effective time window.

### TECHNICAL ADVANTAGES

The disclosed architecture may provide one or more technical advantages. First, it reduces stale configuration by causing a runtime service container to reference a cryptographically verifiable Switch Code record rather than a manually updated local configuration file. Second, it improves incident response by storing a risk state that can be read consistently by distributed services.

Third, it reduces unnecessary disclosure of sensitive data by using selective disclosure proofs during partial freeze and staged unfreeze workflows. Fourth, it improves auditability by generating tamper-evident receipts for policy, deployment, risk, proof, and settlement events. Fifth, it improves energy efficiency by linking ESG metrics to workload scheduling and fee or routing decisions.

These advantages arise from the specific integration of registry state, container deployment, risk-state machine, privacy proof, multi-asset settlement, and energy-aware scheduling. The architecture is not merely a financial business rule applied on a generic computer; it defines a technical control plane for distributed financial service execution.

### Alternative Embodiments

Although some embodiments refer to blockchain, smart contracts, NFTs, DAOs, and DeFi modules, the architecture may be implemented using equivalent tamper-evident registries, permissioned ledgers, cryptographic databases, institutional settlement systems, or hybrid systems. Similarly, a container orchestration module may use Kubernetes, Docker, serverless functions, virtual machines, microservice platforms, edge functions, or equivalent runtime environments.

A Switch Code record may be transferable, non-transferable, account-bound, institution-bound, or regulator-controlled according to policy. A financial endpoint may be represented by a domain, subdomain, DID document, service URI, application identifier, or other namespace basepoint. The system may operate with public or private financial services, centralized or decentralized governance, on-chain or off-chain proof verification, and single or multiple clearinghouses.

The foregoing embodiments are illustrative. Other embodiments may combine the described components in different sequences or distribute the functions across different computing nodes while remaining within the scope of the claimed invention.

### Further Detailed Embodiments and Implementation Details

The following further embodiments provide additional implementation support for the architecture described above. The functions may be performed by separate modules or by combined modules, and the order of operations may be varied unless a particular order is required by the claim language.

The architecture may be implemented as a plurality of cooperating services. A registry service maintains Switch Code records; an orchestration service controls runtime deployment; a compliance gateway evaluates requests; an AI risk service evaluates anomaly signals; a proof service verifies selective-disclosure proofs; a settlement service executes or routes value transfers; an ESG service evaluates workload energy metrics; and an audit service generates tamper-evident receipts.

Each service may communicate by signed messages. A signed message may include a sender identifier, receiver identifier, service role, Switch Code record identifier, timestamp, nonce, policy version, payload hash, signature, and optional proof commitment. Message signing limits spoofing of registry updates and provides a traceable relationship between service events and audit receipts.

### Representative Switch Code Record Schema

In a representative implementation, the Switch Code record is serialized as a structured object. The structured object may be encoded in JSON, CBOR, Protocol Buffers, Solidity storage, database fields, ledger state, or any other machine-readable format. The exact encoding is not critical, provided that the fields can be verified by registry, orchestration, compliance, proof, and settlement components.

A record header may include record_id, registry_id, chain_id or ledger_id, issuer_key_id, policy_version, created_at, updated_at, validity_window, status, and record_hash. An institution section may include legal_name_hash, institution_type, jurisdiction_code, licensing_status, service_categories, domain_endpoint, subdomain_endpoint, and operator_key_id.

A transaction section may include permitted_assets, permitted_currencies, daily_volume_limit, transaction_limit, liquidity_pool_id, oracle_policy_id, fee_schedule_id, settlement_route_id, and exception_route_id. A risk section may include risk_state, ai_model_id, ai_threshold_low, ai_threshold_high, anomaly_score, credit_score_range, fraud_score, freeze_reason_code, freeze_scope, and review_deadline.

A privacy section may include proof_policy_id, proof_type, verification_key_id, allowed_disclosure_fields, prohibited_disclosure_fields, commitment_root, nullifier_namespace, and proof_expiration. A deployment section may include container_image_hash, namespace_id, service_endpoint_url, admission_policy_id, sidecar_policy_id, health_check_url_hash, deployment_hash, and last_migration_receipt.

An ESG section may include node_energy_score, renewable_ratio, carbon_intensity, PUE_value, green_route_enabled, fee_discount_coefficient, carbon_oracle_id, and energy_audit_pointer. An audit section may include receipt_root, last_transaction_receipt, last_freeze_receipt, last_proof_receipt, last_settlement_receipt, and last_policy_update_receipt.

| Field group | Representative fields | Technical use |
|---|---|---|
| Header | record_id, registry_id, | Identifies the record and active rule |
| | policy_version, validity_window | set. |
| Institution | jurisdiction_code, licensing_status, | Binds the service endpoint to an |
| | domain_endpoint | institution or operator. |
| Transaction | fee_schedule_id, oracle_policy_id, | Controls fees, rate sources, and |
| | settlement_route_id | settlement routing. |
| Risk | risk_state, anomaly_score, | Controls dynamic restrictions and |
| | freeze_scope | incident response. |
| Privacy | proof_type, verification_key_id, | Controls selective disclosure and |
| | commitment_root | proof validation. |
| Deployment | container_image_hash, | Controls runtime deployment and |
| | sidecar_policy_id, | admission policy. |
| | deployment_hash | |
| ESG | renewable_ratio, carbon_intensity, | Controls energy-aware routing and |
| | green route_enabled | fee incentives. |
| Audit | receipt_root, | Provides tamper-evident event |
| | last_policy_update_receipt | traceability. |

### Registration Algorithm

A registration algorithm may include the following operations. The system receives a registration request that includes institution credentials, a service category, a domain endpoint, a proposed fee schedule, and a requested deployment class. The system verifies signatures on the submitted credentials and determines whether the institution is authorized under the active policy bundle. The system computes a preliminary risk score from credential status, jurisdiction, history, service scope, and requested transaction limits.

If the preliminary risk score is below a first threshold, the SwitchRegistry creates a Switch Code record in a normal or provisional state. If the preliminary risk score is between a first threshold and a second threshold, the registry creates the record in a provisional or watch state with reduced permissions. If the preliminary risk score exceeds the second threshold, the system rejects the registration request or routes it for manual review.

The registration algorithm may output a registration receipt. The registration receipt may include a registration request hash, approved service category, policy version, initial risk state, assigned record identifier, assigned deployment namespace, and signature of the registry service.

### Container Admission and Runtime Compliance Algorithm

An admission controller may receive a deployment request from a user, operator, CI/CD pipeline, service registry, or orchestration API. The deployment request includes a Switch Code record identifier and a proposed container image hash. The admission controller retrieves the Switch Code record and verifies that the record is active, that the policy version is valid, and that the requested service category is permitted.

If the record is valid, the admission controller attaches a compliance probe to the container. The compliance probe may be a sidecar container, an API gateway plugin, an ingress controller, an egress proxy, middleware, or a library embedded in the service. The probe obtains a local policy cache signed by the SwitchRegistry and periodically refreshes the cache according to the policy bundle.

For each protected request, the compliance probe obtains request attributes such as service type, asset type, transaction amount, jurisdiction, user KYC tier, device risk, and requested settlement route. The probe compares those attributes to the active Switch Code record. When the request is permitted, the probe forwards the request to the financial-service container. When the request is not permitted, the probe denies, limits, holds, or reroutes the request and generates a probe receipt.

A runtime compliance algorithm may also evaluate deployment drift. The probe or sidecar may compute the hash of the running container image, compare the hash against the container_image_hash stored in the Switch Code record, and suspend service if the running image does not match an approved hash. This prevents unauthorized replacement of a compliant service image with an unapproved service image.

### Transaction Permission and Multi-Asset Settlement Algorithm

A transaction permission algorithm may begin when a transaction request is received. The request may specify payer, payee, asset type, amount, jurisdiction, settlement route, purpose code, and service endpoint. Sensitive values may be represented as commitments when privacy preservation is required. The compliance probe or settlement module retrieves the active Switch Code record.

The system determines whether the requested asset type is permitted, whether the amount is below a relevant threshold, whether the KYC tier is sufficient, whether the jurisdiction is allowed, whether the oracle source is authorized, and whether the current risk state permits the requested settlement route. If all required checks pass, the settlement module executes the transaction or prepares settlement instructions. If one or more checks fail, the request is rejected, limited, or routed to a proof-requested state.

In a cross-currency settlement example, the module obtains an exchange rate from an oracle identified by the Switch Code record. The module applies a fee coefficient from the fee schedule and records the oracle source identifier, rate timestamp, fee schedule identifier, and settlement route identifier in a settlement receipt. The receipt may be anchored as a hash commitment to avoid unnecessary publication of sensitive details.

A transaction permission algorithm can continue operating during a partial freeze. The policy bundle may define categories that remain permitted, such as balance inquiry, proof submission, low-value domestic payments, account statement retrieval, or regulator communication. High-value, cross-border, credit, or liquidity-pool operations may be restricted until proof verification or governance approval.

The AI risk engine may use a layered scoring model. A first layer may apply deterministic rules, such as transaction amount thresholds, sanctions indicators, jurisdiction rules, and policy caps. A second layer may apply statistical anomaly detection, such as deviation from historical amount, frequency, counterparties, or timing. A third layer may apply graph analysis, such as clustering of related entities or flow patterns among accounts. A fourth layer may apply machine-learning models trained on labeled or unlabeled risk events.

The risk engine may output a vector rather than a single value. The vector may include fraud risk, credit risk, AML risk, account takeover risk, service compromise risk, oracle manipulation risk, liquidity risk, and infrastructure risk. A policy bundle may map portions of the vector to state transitions. For example, high infrastructure risk may trigger container quarantine, while high AML risk may trigger proof request or multi-sign review.

Model updates may be versioned. An AI model identifier and model version may be stored in the Switch Code record or in a policy bundle. A model update receipt may record the model hash, training data commitment, evaluator identity, effective time window, and rollback procedure. This allows the system to show which model version contributed to a risk-state transition.

The risk engine may also use explainability fields. A risk receipt may include reason codes such as high_velocity, unusual_counterparty, jurisdiction_mismatch, oracle_deviation, device_anomaly, service_image_drift, proof_failure, or ESG_policy_breach. These reason codes allow downstream modules to determine whether a proof, manual review, governance vote, or container migration is the appropriate response.

A risk state transition may be represented by a transition object. The transition object may include prior_state, proposed_state, trigger_event, risk_vector_commitment, policy_version, requesting_actor, required_approvals, expiration_time, and evidence_hash. The SwitchRegistry may verify the transition object before updating the Switch Code record.

A transition from normal to watch may require no governance vote if the risk value exceeds a watch threshold. A transition from watch to partial freeze may require one compliance signature or an automatic threshold event. A transition from partial freeze to full freeze may require multi-signature approval. A transition from proof requested to staged unfreeze may require successful proof verification and may also require a quorum approval.

The risk-state machine may include automatic expiration. For example, a watch state may expire after a defined time unless extended by a new risk event. A partial freeze may require periodic review. A proof-requested state may expire if the required proof is not supplied within a specified time, causing escalation to manual review or full freeze according to policy.

The use of state transition objects improves consistency across distributed services. A container probe, settlement module, and proof verifier can each read the same risk state and the same transition receipt rather than relying on separate local decisions.

### Selective Disclosure and Proof Circuit Examples

A selective disclosure workflow may be implemented with zero-knowledge proofs, verifiable credentials, commitments, or other privacy-preserving techniques. In a range-proof example, the prover commits to a transaction amount and proves that the amount is less than a policy threshold without revealing the exact amount. The proof verifier checks the proof against a verification key identified in the Switch Code record.

In a credential-proof example, a user or institution proves that it holds a credential issued by an authorized issuer and that the credential includes a KYC tier at or above a required tier. The proof may reveal only the satisfaction of the tier condition and not the full credential contents. The proof request may include a challenge nonce to prevent replay.

In a jurisdiction-proof example, an institution proves that a transaction is not associated with a prohibited jurisdiction without disclosing all geographic or identity details. The proof may be generated from a commitment to jurisdiction data and a policy membership proof. A nullifier may prevent the same proof from being reused outside its validity_window.

A proof verification receipt may include proof_request_id, proof_type, verification_key_id, policy_version, challenge_nonce_hash, verification_result, verified_statement_code, and timestamp. The receipt may omit private inputs and may anchor only commitments, thereby preserving privacy while creating an audit trail.

### Staged Unfreeze Examples

A staged unfreeze process may divide privileges into classes. Class A privileges may include read-only account access and proof submission. Class B privileges may include low-value domestic transactions. Class C privileges may include card issuance, loan updates, or liquidity operations. Class D privileges may include cross-border settlement, high-value transfers, or treasury movements.

When a Switch Code record is in a partial freeze state, the system may allow Class A privileges while blocking higher classes. After a first proof verifies, Class B privileges may be restored. After a second proof and governance approval, Class C privileges may be restored. After a regulator or clearinghouse approval, Class D privileges may be restored.

This staged approach improves service continuity. Instead of fully disabling an institution or user endpoint for all functions, the system restricts only the functions associated with the unresolved risk. The restored privilege classes are recorded in the Switch Code record and referenced in the audit receipt.

### Multi-Signature and Role-Based Governance

Governance roles may include institution administrator, compliance officer, AI auditor, clearinghouse operator, regulator node, ESG auditor, oracle administrator, and emergency recovery signer. Each role may be associated with permitted operations and signature thresholds. The policy bundle may define which role combinations are required for each operation.

For example, a fee schedule update may require an institution administrator and compliance officer. A full freeze may require a compliance officer, clearinghouse operator, and regulator node. An oracle source change may require an oracle administrator and registry operator. A post-quantum key rotation may require an emergency recovery signer and registry operator.

The governance contract or service may reject signatures from keys that are expired, revoked, outside their role scope, or not bound to the active policy version. A governance receipt may include the operation type, signer commitments, quorum threshold, approval time, policy version, and resulting Switch Code state.

### Beehive Scheduler Detailed Operation

A Beehive scheduler may compute a placement score for each candidate node. The placement score may be based on capacity score, latency score, renewable energy score, carbon score, jurisdiction score, data-residency compatibility, service redundancy, and current risk state. Hard constraints may be applied before optimization. For example, a node outside a permitted jurisdiction may be excluded regardless of energy score.

A representative placement score may be computed as a weighted sum of normalized node metrics. The weights may be defined in the policy bundle. For a payment service, latency and compliance jurisdiction may receive higher weights. For batch reconciliation, renewable energy and cost may receive higher weights. For an endpoint in a watch state, redundancy and audit availability may receive higher weights.

The scheduler may operate in an observe-plan-act-verify loop. It observes telemetry, plans a migration or placement, acts by instructing the orchestrator to move or scale a container, and verifies that the container is running with the approved image hash and compliance probe. The scheduler then causes an ESG or deployment receipt to be generated.

A workload migration may be rejected when migration would violate data residency, reduce redundancy below a threshold, break a cryptographic session, or place the service on a node lacking an approved compliance probe. In such a case, the scheduler may choose a less optimal node that satisfies all hard constraints.

### Interoperability and Endpoint Records

A financial service endpoint may publish an endpoint record. The endpoint record may include endpoint_id, domain_name, service_role, registry_endpoint, proof_endpoint, policy_endpoint, settlement_endpoint, audit_endpoint, public_key_id, policy_version, validity_window, and signature. The endpoint record may be stored in DNS, DNSSEC-protected records, DID documents, a registry contract, or a signed configuration repository.

The endpoint record allows external systems to discover where to submit proof objects, settlement messages, audit queries, or policy requests. Because the endpoint record is signed and versioned, a client can determine whether a discovered endpoint is authorized and current. The endpoint record may be referenced by the Switch Code record to bind the financial service identity to the service routing layer.

A clearinghouse adapter may map internal settlement messages to external payment or banking message formats. The adapter may preserve the Switch Code record identifier and policy version as structured metadata or as a reference value. Such mapping allows the architecture to interact with existing financial rails while retaining auditability.

### Replay Prevention and Failure Codes

The system may prevent replay by including nonces, counters, session identifiers, validity windows, and nullifier values. A proof request may include a challenge nonce. A transaction receipt may include a transaction nonce and a policy version. A governance vote may include an operation identifier and expiration time. A settlement instruction may include a unique instruction identifier.

Representative machine-readable failure-code identifiers may include, without limitation, POLICY_EXPIRED, RECORD_SUSPENDED, KYC_TIER_INSUFFICIENT, AML_THRESHOLD_EXCEEDED, ORACLE_NOT_AUTHORIZED, RISK_STATE_RESTRICTED, PROOF_REQUIRED, PROOF_FAILED, QUORUM_NOT_MET, CONTAINER_HASH_MISMATCH, ENDPOINT_SIGNATURE_INVALID, ESG_ROUTE_UNAVAILABLE, and SETTLEMENT_ROUTE_BLOCKED. The foregoing capitalized code identifiers are illustrative identifiers and may be replaced, mapped, translated, or encoded using equivalent status labels, numeric codes, protocol messages, or structured error objects.

Failure codes may be stored in audit receipts. A failure receipt may include the code, the Switch Code record identifier, policy version, actor commitment, and time. Recording failures improves debugging, auditability, compliance analysis, and dispute resolution.

### Security and Key Management

Key management may be performed using institutional keys, hardware security modules, threshold keys, secure enclaves, wallet keys, post-quantum keys, or combinations thereof. A key may be scoped to a role and a policy_version. A service key may be limited to deployment approvals, while a governance key may be limited to freeze decisions.

A key rotation event may be required when a key is compromised, expired, upgraded, or replaced by a post-quantum key. The rotation event may require governance approval. The resulting key rotation receipt may update the Switch Code record or endpoint record. A compliance probe may reject messages signed by a revoked key after the effective time of the rotation.

The system may also support emergency controls. An emergency control may temporarily restrict a service endpoint, pause high-risk settlement routes, disable a compromised oracle source, or require stronger proof for selected operations. Emergency controls may be time-limited and may require later review.

### Scalability and Distributed Deployment

The architecture may be scaled by separating high-frequency request evaluation from lower-frequency registry updates. A compliance probe may cache signed policy bundles and Switch Code commitments for a short validity window, reducing registry calls while preserving verifiability. The cache may be invalidated by a policy update, risk-state transition, or revocation event.

Settlement receipts and detailed logs may be batched. A batch root may be anchored in a tamper-evident structure, while detailed receipt data may remain in secure storage. This reduces ledger load while preserving the ability to verify individual receipts.

Proof verification may be distributed. A proof service may verify high-volume proofs off-chain and anchor verification receipts. For high-assurance events, proof verification may be performed by multiple verifiers or by a verifier whose key is recognized in the policy bundle.

### Additional Use Cases

A regulated stablecoin issuer may use the architecture to bind issuer service endpoints to Switch Code records. The compliance probe can prevent minting, redemption, or transfer operations when the issuer record enters a proof-requested or partial-freeze state.

A bank-as-a-service provider may use the architecture to deploy separate service containers for multiple partner institutions. Each partner institution has a separate Switch Code record. A shared orchestration layer deploys services, but each compliance probe reads the corresponding partner-specific record and policy bundle.

A cross-border remittance provider may use the architecture to route transfers through jurisdictions according to Switch Code policy. A proof requirement may be triggered for high-value or unusual transfers, while ordinary transfers continue within limits.

A green-finance platform may use ESG values in Switch Code records to adjust transaction fees or routing priority. Workloads associated with institutions satisfying renewable thresholds may receive lower infrastructure fees or preferred routing.

A credit provider may use a privacy-preserving proof to show that a borrower falls within a permitted credit range without revealing the full credit file. A staged unfreeze may restore lending functions after proof verification.

### Domain-Branded Future Banking Deployment Examples

In some embodiments, the Switch Code architecture may be deployed behind a public-facing future-banking portal. For example, a human-readable domain or namespace basepoint such as FutureBank.com, or an equivalent future-bank identifier, may provide a user, institutional, or investor-facing entry point, while the backend permissions, risk state, privacy proof requirements, settlement eligibility, and audit receipts are controlled by one or more Switch Code records. In such an embodiment, the domain name is not merely a marketing label; it resolves, directly or indirectly, to signed endpoint records for policy retrieval, proof submission, wallet access, transaction routing, settlement, and compliance audit.

In some embodiments, a top-level financial infrastructure namespace, such as ATMS.com or an equivalent namespace basepoint, may host a plurality of sub-bank, payment, credit, wallet, remittance, or settlement endpoints. A subdomain such as a bank-specific, merchant-specific, regional, or service-specific endpoint may be mapped to a corresponding Switch Code record. The Switch Code record may determine which container image, compliance probe, policy sidecar, risk-state rule set, oracle policy, and settlement adapter are attached to the deployed service container.

In some embodiments, a branded banking namespace such as 168bank.com, or an equivalent banking-domain basepoint, may operate as a franchise, partner-bank, community-bank, or thematic-bank node. A Switch Code record associated with the branded banking node may encode the service authorization, permitted products, jurisdictional scope, fee schedule, reserve or collateral requirements, ESG routing preferences, and staged freeze/unfreeze permissions for that node. This allows different branded banking nodes to share a common Switch Code control plane while maintaining separate policies, branding, settlement routes, and compliance responsibilities.

In some embodiments, an application-domain basepoint such as MF.app, or an equivalent mobile or application namespace, may provide a mobile interface, wallet interface, merchant interface, or developer interface to the Switch Code network. The application interface may submit signed requests to the registry, receive proof challenges, display risk or freeze-state notifications, obtain settlement receipts, and route user actions to an authorized financial service endpoint. The mobile or application namespace does not replace the Switch Code record; rather, it functions as a front-end or edge access layer controlled by the registry state and policy bundle.

In some embodiments, a Switch Code registry or standards endpoint may be presented through a protocol or certification namespace, including, for example, beiswitch.com, beiswitchcode.com, switchcode.org, switchcode.app, or equivalent registry, application, or standardization identifiers. Such endpoints may publish technical specifications, endpoint-record schemas, compliance profiles, certification rules, developer sandboxes, or node-registration instructions. The presence or absence of a particular domain name does not limit the invention, because the described functions may be implemented using any resolvable identifier, namespace record, ledger address, service registry, or signed endpoint record.

The foregoing domain-branded examples are non-limiting deployment illustrations. The claimed architecture does not require any specific domain name, trademark, registrar, top-level domain, or public DNS implementation. A Switch Code record may be mapped to a domain, subdomain, decentralized identifier, service registry entry, account-bound credential, ledger address, enterprise namespace, or other resolvable identifier. These examples show how the technical control plane can support future banking portals, ATMS-style financial infrastructure, branded bank nodes, mobile application access, and standard or certification endpoints while preserving the same registry, policy, risk, privacy, settlement, and audit mechanisms described above.

### BEIFlow and Bank-Rail Flow Deployment Examples

In some embodiments, a flow-oriented namespace such as BEIFlow.com, or an equivalent flow-control identifier, may provide a technical front end for initiating, tracking, proving, and reconciling payment, remittance, credit, settlement, or correction flows. A BEIFlow endpoint may receive a signed request associated with a BEI identity, account-bound credential, domain endpoint, wallet, or financial service node, and may route the request to a corresponding Switch Code record for policy-controlled execution.

A BEIFlow workflow may operate across delayed or heterogeneous payment rails, including automated clearing house transfers, same-day clearing rails, instant-payment rails, card-network rails, stablecoin rails, internal ledger rails, or future settlement networks. The Switch Code record may identify the selected rail, expected settlement window, policy_version, risk state, proof requirement, provisional-credit eligibility, final-settlement status, and correction status. In this manner, a delayed bank-transfer process can be represented as a machine-readable flow state rather than as an opaque pending transaction.

In some embodiments, when a bank transfer is initiated outside ordinary banking hours, during a weekend, or before a receiving institution posts final settlement, the system may issue a pending-settlement receipt. The pending-settlement receipt may record identity verification, endpoint verification, payment-rail selection, risk acceptance, policy state, proof state, provisional release conditions, expected settlement window, and a later final-settlement, failed-settlement, returned-payment, or FR2 correction status.

In some embodiments, a merchant, service provider, wallet, lending node, remittance node, or future-bank portal may use the pending-settlement receipt to determine whether to release a service, apply a provisional credit, require an additional proof, limit a transaction amount, block a settlement route, or await final settlement. The decision may be made by the Switch Code state machine using one or more of a BEI identity status, KYC tier, AML threshold, account verification result, historical return rate, transaction amount, rail type, proof object, and policy-defined risk tolerance.

In some embodiments, BEIFlow operates as a flow-status and receipt layer rather than as a replacement for a bank payment rail. A bank, clearinghouse, card network, instant-payment network, digital-asset rail, or internal ledger may perform the underlying transfer or settlement, while the BEIFlow and Switch Code layers provide identity-linked status tracking, policy enforcement, risk-state gating, proof challenge handling, receipt issuance, final reconciliation, and correction or rollback evidence.

The foregoing BEIFlow examples are non-limiting deployment illustrations. The described flow-control functions may be implemented using any domain, subdomain, decentralized identifier, signed endpoint record, enterprise service registry, ledger address, API gateway, wallet endpoint, or equivalent resolvable identifier. A particular BEIFlow.com domain name is not required to practice the invention; rather, the technical feature is the machine-readable coordination of flow state, Switch Code policy state, pending and final settlement receipts, and optional FR2 correction status.

### SWIFT/BIC, Card-Network, and Companion-Layer Interoperability Examples

In certain embodiments, the Switch Code architecture may interoperate with conventional financial institution identifiers, banking-message formats, payment-network identifiers, or clearing identifiers, including SWIFT/BIC-style identifiers, ISO 20022-compatible message structures, routing numbers, account tokens, card-network references, instant-payment references, digital-asset addresses, or equivalent settlement references. Such external identifiers may identify an institution, account, route, message, or rail, while the Switch Code record provides a separate machine-readable control state for policy enforcement, risk-state transition, proof gating, deployment control, settlement eligibility, and audit receipt generation.

In certain embodiments, the Switch Code record may store or reference an external banking or payment identifier without becoming limited to that identifier. For example, an external banking identifier may identify where a payment message is routed, while the Switch Code record determines whether a financial service node, transaction request, proof submission, containerized service, provisional-credit action, or settlement route is active, restricted, frozen, proof-required, settlement-blocked, or eligible for execution under a current policy state.

In certain embodiments, card networks, bank-transfer networks, check-clearing systems, instant-payment networks, stablecoin rails, internal ledgers, or future settlement systems may perform the underlying funds movement or message transmission. The Switch Code and BEIFlow layers may operate above or alongside such rails to provide identity-linked status tracking, policy evaluation, risk-state gating, proof challenge handling, receipt issuance, final reconciliation, and FR2 correction evidence.

### Companion BEI Control-Stack Layer Examples

In certain embodiments, the Switch Code layer may operate with one or more companion BEI control-stack layers. A BRI3, receptor, event-intake, or evidence-reception layer may receive behavioral events, payment events, transaction requests, proof objects, sensor records, oracle messages, document hashes, or other evidence objects. Such a layer may normalize an input into an event envelope containing an event type, source identifier, actor commitment, payload commitment, timestamp, policy reference, and optional receipt anchor.

In certain embodiments, a BEISign, SIGN, authorization, or consent-binding layer may bind an actor, institution, wallet, device, administrator, regulator node, or multi-party quorum to an authorization event. An authorization receipt may include a signer commitment, signature scheme, role identifier, consent scope, operation identifier, expiration time, policy version, and resulting approval status. The authorization layer answers who approved an operation, while the Switch Code layer determines whether the approved operation may be executed under the current policy and risk state.

In certain embodiments, the Switch Code layer differs from an event-intake layer, signing layer, object layer, finder layer, wallet layer, minting layer, clearing layer, or correction layer by acting as an execution-control state machine. The Switch Code layer evaluates identity state, policy version, risk state, proof requirement, freeze state, deployment endpoint, settlement route, and audit-receipt rules to determine whether an operation is allowed, restricted, held, proof-required, frozen, unfrozen, blocked, or eligible for execution.

In certain embodiments, an FR2, fair-rollback, correction, or recovery layer may operate after a Switch Code decision or receipt has been issued. If an authorization, risk score, proof result, banking rail status, payment return, check return, freeze action, settlement route, or other decision is later determined to be erroneous, disputed, fraudulent, incomplete, or superseded, the FR2 layer may generate a correction receipt, rollback receipt, recovery receipt, or superseding receipt while preserving the original receipt as historical evidence.

### Receipt Product and Delayed-Rail Bridge Example

In certain embodiments, receipts generated by the architecture may include registration receipts, authorization receipts, proof-request receipts, proof-verification receipts, risk-transition receipts, container-admission receipts, freeze receipts, unfreeze receipts, pending-settlement receipts, final-settlement receipts, failed-settlement receipts, check-deposit receipts, check-return receipts, correction receipts, rollback receipts, and recovery receipts. Each receipt may include a receipt identifier, Switch Code record identifier, policy version, actor commitment, event commitment, decision state, reason code, timestamp, signature, and optional hash anchor.

In a delayed-rail or check-processing example, the system may receive a check image hash, deposit request, payer commitment, payee commitment, bank-route token, account-reference token, amount commitment, or clearing-status message. The Switch Code state machine may determine whether the deposit is eligible for provisional availability, whether a hold should be applied, whether additional proof should be requested, and whether a later cleared, returned, stopped, fraudulent, or corrected state should be recorded in a receipt.

In certain embodiments, a pending-to-final receipt model may be used for automated clearing house transfers, check deposits, card-settlement delays, cross-border remittances, instant-payment exceptions, internal-ledger transfers, or stablecoin settlement. A pending receipt may be issued before final settlement, and a final, failed, returned, reversed, or FR2-corrected receipt may later be linked to the pending receipt. The linked receipts allow a merchant, service provider, wallet, lender, exchange, clearinghouse, or future-bank portal to apply a policy-defined provisional release while retaining an auditable path to final reconciliation.

The architecture is not limited to ordinary credit approval, loan underwriting, payment receipts, accounting receipts, or conventional audit logs. A credit score, underwriting decision, third-party verification, bank confirmation, or payment receipt may be used as an input, but the Switch Code layer provides a distinct machine-readable execution-control state that coordinates node authorization, runtime service behavior, proof requirements, freeze state, settlement eligibility, receipt generation, and optional correction.

In certain embodiments, a namespace, domain, decentralized identifier, enterprise registry, service registry, wallet endpoint, or ledger address may provide access to the foregoing layers. Such identifiers may include non-limiting deployment examples used by a future banking portal, ATMS-style infrastructure namespace, BEIFlow status endpoint, Switch Code registry endpoint, or standards endpoint. A particular domain name, brand, payment network, or banking rail is not required to practice the invention.

The foregoing interoperability and companion-layer examples are non-limiting. The invention may be implemented using fewer, additional, or differently named modules, provided that a machine-readable control state is used to evaluate policy, risk, proof, deployment, settlement, and receipt conditions for a financial service node or related operation.

### Claim Support and Anchors

The system claims are supported by the described SwitchRegistry, Switch Code record, container orchestration module, compliance probe, multi-asset settlement module, AI risk engine, privacy-preserving proof verifier, ESG scheduler, and audit module. The method claims are supported by the described registration, deployment, transaction permission, risk computation, state transition, proof request, proof verification, and receipt generation workflows.

The computer-readable medium claims are supported by the described executable instructions stored in one or more memories. The instructions cause processors to maintain registry state, deploy containers, configure compliance probes, determine transaction permissions, compute risk values, transition risk states, verify proofs, execute or restrict settlement, and generate receipts.

The specification intentionally describes the Switch Code record as a class of tamper-evident state objects rather than only one token standard. This preserves implementation flexibility while maintaining the technical core: a policy-controlled state object that drives runtime service behavior and settlement control.

What is claimed is:

1. A computer-implemented system for operating policy-controlled financial-service endpoints across distributed ledgers and containerized computing environments, comprising:
(a) a SwitchRegistry configured to maintain a tamper-evident Switch Code record for a participating institution or financial-service endpoint;
(b) one or more memories storing the Switch Code record, the Switch Code record including at least an institution identifier, a domain or namespace endpoint, a policy version, a fee schedule identifier, a risk state, a privacy-proof policy, a settlement route, a container endpoint identifier, an ESG metric, and an audit pointer;
(c) a container orchestration module configured to deploy a financial-service container associated with the Switch Code record;
(d) a compliance probe associated with the financial-service container and configured to read or verify the Switch Code record before permitting a protected service operation;
(e) a multi-asset settlement module configured to process a transaction request according to the policy version, fee schedule identifier, settlement route, and risk state;
(f) an artificial-intelligence risk engine configured to compute a risk value from transaction data or operational telemetry and update or recommend updating the risk state;
(g) a privacy-preserving proof verifier configured to verify a compliance attribute without disclosing underlying sensitive data; and
(h) an audit module configured to generate a tamper-evident receipt for at least one of registration, deployment, transaction permission, risk-state transition, proof verification, settlement, freeze, unfreeze, ESG update, or correction,
wherein the compliance probe controls runtime behavior of the financial-service container according to the machine-verifiable Switch Code record.

2. The system of claim 1, wherein the Switch Code record comprises a header portion, an identity portion, a compliance portion, a transaction portion, a risk portion, a deployment portion, a privacy portion, an ESG portion, and an audit portion.

3. The system of claim 1, wherein the compliance probe is implemented as a sidecar container, an admission controller, an API gateway plugin, an ingress controller, an egress proxy, middleware, a smart-contract call, or a library embedded in the financial-service container.

4. The system of claim 1, wherein the compliance probe is configured to output an allow action, deny action, rate-limit action, route action, log action, hold action, proof-request action, freeze action, or unfreeze action according to the Switch Code record.

5. The system of claim 1, wherein the risk state includes at least one of normal, watch, rate-limited, partial freeze, proof requested, manual review, full freeze, staged unfreeze, and restored.

6. The system of claim 1, wherein the privacy-preserving proof verifier verifies a zero-knowledge proof, verifiable credential, commitment, range proof, threshold signature, secure-enclave attestation, or equivalent privacy-preserving proof object.

7. The system of claim 1, wherein a governance module comprising a multi-signature contract, DAO contract, regulator node, compliance committee node, institutional administrator node, or quorum-based approval mechanism approves a freeze, partial freeze, staged unfreeze, revocation, policy update, audit export, or settlement exception operation.

8. The system of claim 1, wherein an energy-aware scheduler selects, migrates, replicates, or deprioritizes the financial-service container according to renewable-energy ratio, carbon score, data-center efficiency, network latency, load, jurisdictional compatibility, risk-state requirements, or service availability requirements.

9. A computer-implemented method for operating a policy-controlled financial-service endpoint, comprising:
(a) receiving registration information for an institution or financial-service endpoint;
(b) creating or updating, by a SwitchRegistry, a tamper-evident Switch Code record including a policy version, service scope, fee schedule, KYC or AML parameter, risk state, proof requirement, container endpoint, settlement route, ESG metric, and audit pointer;
(c) deploying, by a container orchestration module, a financial-service container associated with the Switch Code record;
(d) configuring a compliance probe associated with the financial-service container to read or verify the Switch Code record before permitting a service operation;
(e) receiving a transaction or service request;
(f) determining, by the compliance probe or a settlement module, whether the transaction or service request is permitted according to the Switch Code record;
(g) computing, by an artificial-intelligence risk engine, a risk value from transaction data, behavior data, credit data, compliance data, sanctions data, device data, network data, or operational telemetry;
(h) transitioning or recommending transition of the risk state according to the risk value and the policy version; and
(i) generating a tamper-evident receipt associated with the request, risk-state transition, proof verification, settlement result, or audit event.

10. The method of claim 9, wherein creating or updating the Switch Code record comprises assigning the Switch Code record to a normal state, provisional state, watch state, or manual-review state according to credential verification, jurisdiction, service scope, transaction limits, licensing status, ESG disclosure, or risk screening.

11. The method of claim 9, wherein determining whether the transaction or service request is permitted comprises comparing request attributes including service type, asset type, amount, jurisdiction, KYC tier, device risk, and settlement route against the Switch Code record.

12. The method of claim 9, further comprising generating a proof request when the risk state is proof requested or partial freeze and restoring selected privileges after verifying a privacy-preserving proof.

13. The method of claim 9, further comprising anchoring a settlement receipt that includes a transaction commitment, rate identifier, fee identifier, policy version, and audit anchor.

14. The method of claim 9, further comprising migrating or routing the financial-service container to a lower-carbon or policy-compliant node when an ESG metric satisfies a policy-defined migration condition.

15. A non-transitory computer-readable medium storing instructions that, when executed by one or more processors, cause the one or more processors to:
(a) maintain a tamper-evident Switch Code record for a financial-service endpoint;
(b) deploy or authorize deployment of a financial-service container associated with the Switch Code record;
(c) configure a compliance probe to verify the Switch Code record before protected service execution;
(d) process a transaction request according to a policy version, fee schedule, risk state, proof requirement, settlement route, and audit pointer stored in or referenced by the Switch Code record;
(e) compute or receive a risk value and transition or recommend transition of the risk state;
(f) verify a privacy-preserving proof in response to a proof request or partial-freeze state;
(g) execute, restrict, defer, route, hold, freeze, unfreeze, or settle the transaction request according to the risk state and policy version; and
(h) generate a tamper-evident receipt for a deployment, request, proof, settlement, risk transition, governance approval, ESG update, or correction event.

16. The non-transitory computer-readable medium of claim 15, wherein the Switch Code record is serialized using JSON, CBOR, Protocol Buffers, smart-contract storage, database fields, ledger state, or another machine-readable encoding.

17. The non-transitory computer-readable medium of claim 15, wherein the instructions further cause the one or more processors to compare a running container image hash against an approved container image hash stored in or referenced by the Switch Code record and suspend or restrict service when deployment drift is detected.

18. The non-transitory computer-readable medium of claim 15, wherein the instructions further cause the one or more processors to interact with a card network, bank-transfer network, check-clearing system, instant-payment network, stablecoin rail, internal ledger, or future settlement system while using the Switch Code record to control eligibility, routing, proof requirements, receipts, or correction.

19. The non-transitory computer-readable medium of claim 15, wherein the instructions further cause the one or more processors to exchange signed messages that include a sender identifier, receiver identifier, Switch Code record identifier, timestamp, nonce, policy version, payload hash, signature, or proof commitment.

20. The non-transitory computer-readable medium of claim 15, wherein the instructions further cause the one or more processors to rotate cryptographic verification material or use quantum-resistant or post-quantum signature schemes for Switch Code ownership, governance approval, proof verification, audit receipts, or key-rotation events.
